(19) United States
(12) Patent Application Publication
(10) Pub. No.: US 2016/0205513 A1
(43) Pub. Date: Jul. 14, 2016

(54) SYSTEM AND METHOD FOR LOCATING AN INDIVIDUAL INDOORS BY A COMBINATION OF WIRELESS POSITIONING SENSORS

(71) Applicant: Rajiv Kumar CHOUDHRY, New Delhi (IN)

(72) Inventor: Rajiv Kumar CHOUDHRY, New Delhi (IN)

(21) Appl. No.: 14/914,503

(22) PCT Filed: Aug. 25, 2014
(86) PCT No.: PCT/IN2014/000545

§ 371 Date: Feb. 25, 2016

(30) Foreign Application Priority Data
Aug. 27, 2013 (IN) 2531/DEL/2013

(51) Int. Cl. H04W 4/04; H04W 4/22; G01C 21/20

(52) U.S. Cl. CPC H04W 4/043; G01C 21/206; H04W 4/22

(57) ABSTRACT

An indoor map is generated using a combination of signaling of a wireless router, and combining them with indoor location specific user walk-path data. The positioning data is sent to a network operator. In one embodiment, an 802.11 Router is mounted on a wall close to the ceiling with antennae tilted downwards and location address related information fed into the Router itself. The positioning map is transmitted to a cellular operator over a cellular transmission such as GSM, WCDMA LTE, etc. The signaling between smartphone and cellular RAT is reduced by mapping/converting the RSSI data with that of location specific walk-way data into a grid based format. The positioning data so generated is transferred periodically to an operator, who further transfers the data to a gateway manager. A gateway manager stores the data received from a smartphone user and provides it to authorized personnel in case of emergencies.

### FIELD OF INVENTION

The invention is in the field of locating an individual indoors by using a combination of signals in conjunction with wireless signal monitoring equipment. This invention may also be used to specify the position of an individual indoors, and in one example may also be used as a disaster management tool to locate last known user position in case of an earthquake, fire, etc.

### BACKGROUND

There are many ways in the field of wireless communications by which a user's physical position may be determined with a degree of accuracy depending on the technique of positioning used. However one drawback of these techniques is that they have an inherent degree of error with respect to locating the exact position of a user in a building.

A technique known as Pedestrian Dead Reckoning (PDR) uses existing sensor-based solutions involving an accelerometer to count steps, a magnetometer and/or gyroscope to measure changes in walking direction. The accuracy of these methods varies between 0.5% and 10% of distance traveled. An additional drawback of these PDR techniques is that they require a user to strap around a mobile sensing device stationary with respect to their body at all times.

A commonly used mobile sensing device is a device commonly called as a smartphone. A smartphone may come with a “normal commercial grade” accelerometer, a magnetometer and a software defined gyroscope. These “normal commercial grade” smartphones cannot render precise location because of the inherent grade of the components used. Industrial (IND) or Military (MIL) grade components cannot be used for consumer products because they are extremely expensive.

An additional issue involved in indoor positioning using a smartphone is that the controlling software in the phone needs to allow for natural movement, providing reasonable results, independent of how the smartphone is carried. The software controlling the smartphone also needs to take into account multiple factors, and the software render results real time.

There is research that reflects that most of the users spend time indoors in homes, offices, shopping malls, libraries, airports or university or office campuses. Another research reflects that up to 70% of calls and 80% of data connections to a basestation originate indoors. Because users spend a large amount of time indoors, there is a need to provide an inexpensive way to locate user position with a degree of accuracy.

### SUMMARY

The location of a user indoors may be specified to a degree of accuracy by use of an indoor map. An indoor map is generated using the signals of a base station of a wireless router not employing cellular radio access technology. In one embodiment, an 802.11 Router is mounted on a wall close to the ceiling, and the embodiment utilizes periodic measurements of wireless radio signal strength indication (RSSI) and transmitting the same to a to a cellular operator over a cellular RAT such as GSM, WCDMA LTE, etc. The cellular operator stores the data received from a smartphone user and provides it to emergency personnel in emergencies.

Other objects, features, and advantage of the present invention will become apparent from the following detailed description.

### BRIEF DESCRIPTION OF DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example portable communication device (UE)/user equipment (UE) that may be used within the communications system illustrated in FIG. 1A;

FIG. 1C is a system diagram of an example radio access network and an example core network that may be used within the communications system illustrated in FIG. 1A;

FIG. 2 is the actual floor plan of an indoor location with a WiFI Router mounted at one end;

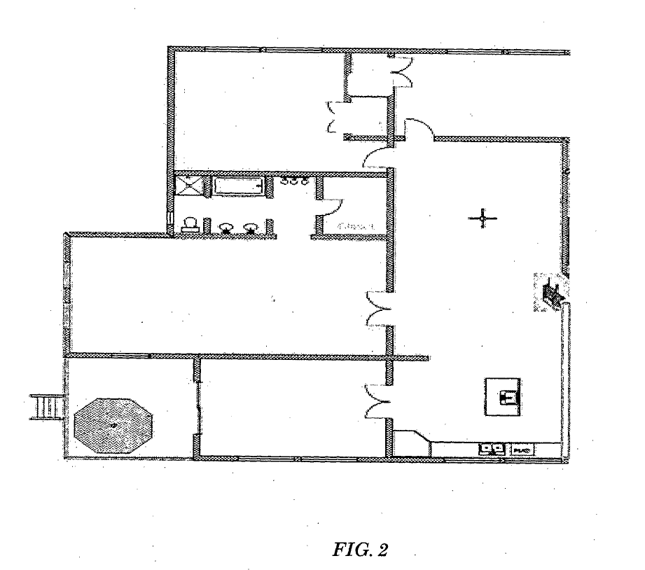

FIG. 3 is representation of the movement pattern of a user of the indoor location of FIG. 2;

FIG. 4 is representation of the received signal strength indication of the WiFi Router in the indoor location—as represented in FIG. 4, areas closer to the WiFi Router have a higher signal strength;

FIG. 5 is a representation of the superimposition of the movement pattern of a user with that of the signal strength; and

FIG. 6 is flow diagram of the signaling involved in the location process.

### DETAILED DESCRIPTION

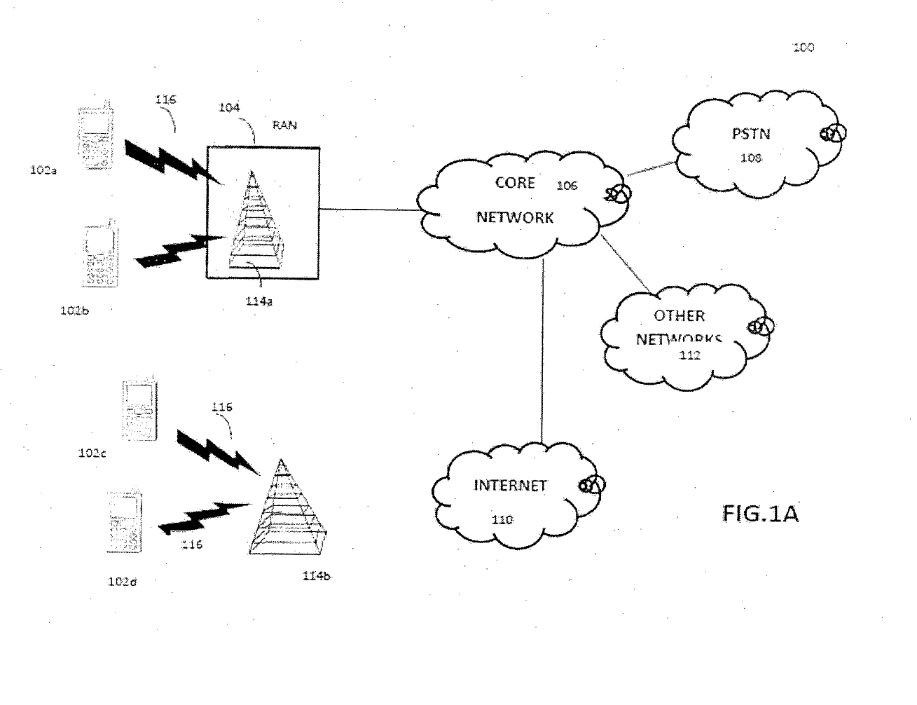

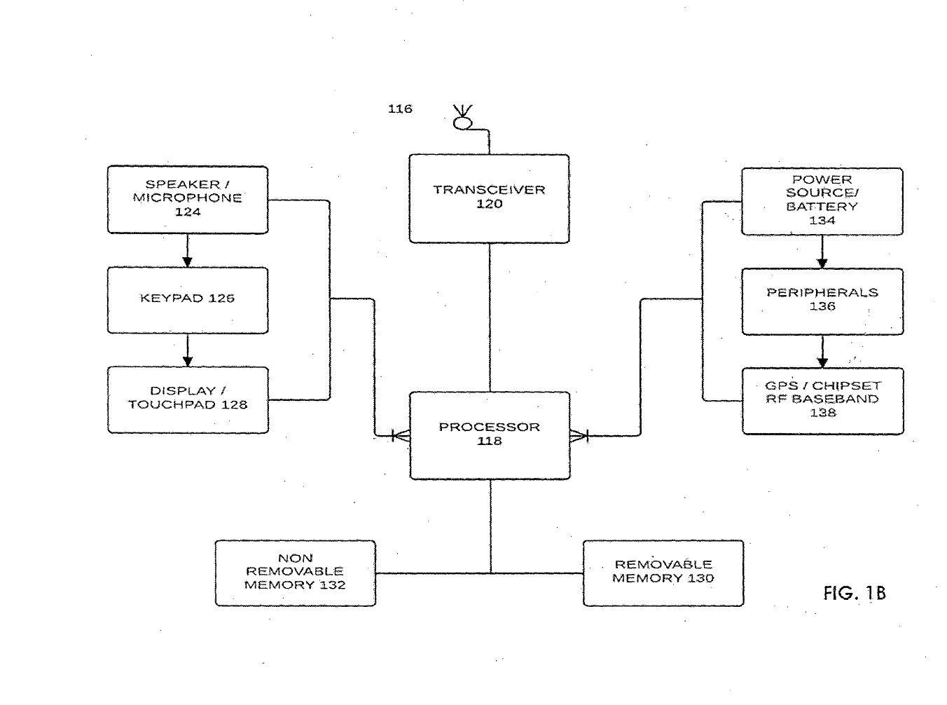

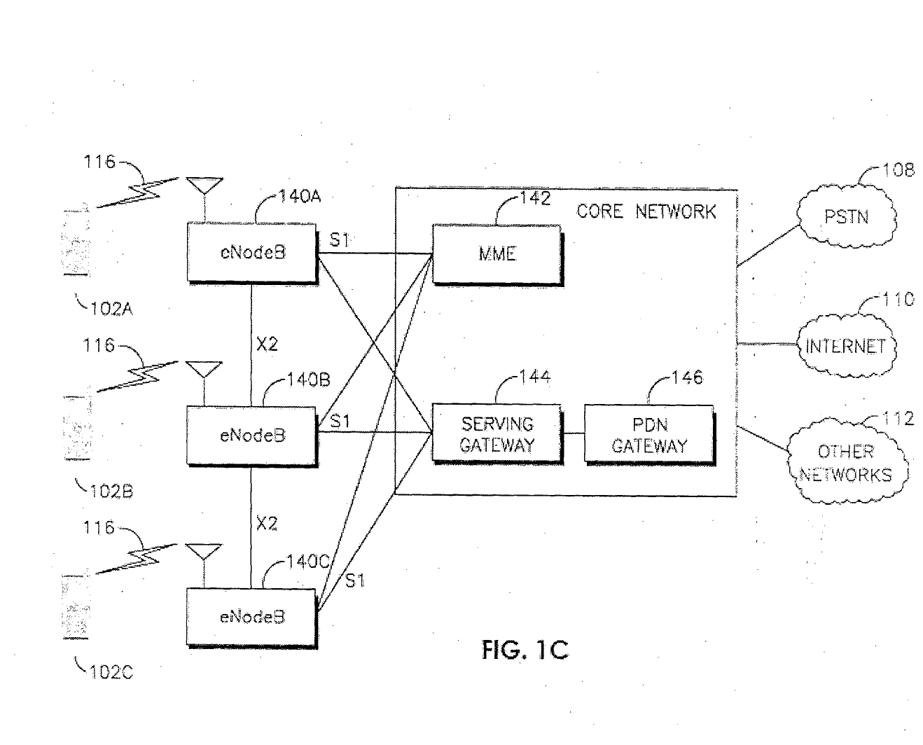

FIG. 1A is a diagram of an example communications system 100 in which one or more disclosed embodiments for locating a user indoors may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SCFDMA), and the like.

As shown in FIG. 1A, the communications system 100 may include portable communication devices (UEs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of UEs, base stations, networks, and/or network elements. Each of the UEs 102a, 102b, 102c, 102d may be any type of device configured to operate and/or communicate in a wireless environment. By way of example, the UEs 102a, 102b, 102c, 102d may be configured to transmit and/or receive wireless signals and may include user equipment (UE), a mobile station, a fixed or mobile subscriber unit, a pager, a celhilar telephone, a personal digital assistant (PDA), a smartphone, a laptop, a netbook, a personal computer, a wireless sensor, consumer electronics, and the like.

The communications system 100 may also include a base station 114a and a base station 114b. Each of the base stations 114a, 114b may be any type of device configured to wirelessly interface with at least one of the UEs 102a, 102b, 102c, 102d to facilitate access to one or more communication networks, such as the core network 106, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell. The base stations 114a, 114b may communicate with one or more of the UEs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the UEs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the UEs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the UES 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the UEs 102c, 102d may implement a radio technology such as IEEE 802.11 to establish a wireless local area network (WLAN). In another embodiment, the base station 114b and the UEs 102c, 102d may implement a radio technology such as IEEE 802.15 to establish a wireless personal area network (WPAN). In yet another embodiment, the base station 114b and the UEs 102c, 102d may utilize a cellular based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the UEs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the UEs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCPIIP internet protocol suite. The other networks 112 may include wired or wireless communications networks owned and/or operated by other service providers. For example, the other networks 112 may include another core network connected to one or more RANs, which may employ the same RAT as the RAN 104 or a different RAT. Some or all of the UEs 102a, 102b, 102c, 102d in the communications system 100 may include multi-mode capabilities, i.e., the UEs 102a, 102b, 102c, 102d may include multiple transceivers for communicating with different wireless networks over different wireless links. For example, the UE 102c shown in FIG. 1A may be configured to communicate with the base station 114a, which may employ a cellular-based radio technology, and with the base station 114b, which may employ an IEEE 802 radio technology.

FIG. 1B is a system diagram of an example UE 102. As shown in FIG. 1B, the UE 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the UE 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the UE 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the UE 102 may include any number of transmit/receive elements 122. More specifically, the UE 102 may employ MIMO technology. Thus, in one embodiment, the UE 102 may include two or more transmit/receive elements 122 (e.g., multiple antennas) for transmitting and receiving wireless signals over the air interface 116. The transceiver 120 may be configured to modulate the signals that are to be transmitted by the transmit/receive element 122 and to demodulate the signals that are received by the transmit/receive element 122. As noted above, the UE 102 may have multi-mode capabilities. Thus, the transceiver 120 may include multiple transceivers for enabling the UE 102 to communicate via multiple RATS, such as UTRA and IEEE 802.11, for example.

The processor 118 of the UE 102 may be coupled to, and may receive user input data from, the speaker/microphone 124, the keypad 126, and/or the display/touchpad 128 (e.g., a liquid crystal display (LCD) display unit or organic light emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the UE 102, such as on a server or a home computer (not shown).

The processor 118 may receive power from the power source 134, and may be configured to distribute and/or control the power to the other components in the UE 102. The power source 134 may be any suitable device for powering the UE 102. For example, the power source 134 may include one or more dry cell batteries (e.g., nickel-cadmium (NiCd), nickel-zinc (NiZn), nickel metal hydride (NiMH), lithium ion (Li-ion), etc.), solar cells, fuel cells, and the like.

The processor 118 may also be coupled to the GPS chipset 136, which may be configured to provide location information (e.g., longitude and latitude) regarding the current location of the UE 102. In addition to, or in lieu of, the information from the GPS chipset 136, the UE 102 may receive location information over the air interface 116 from a base station (e.g., base stations 114a, 114b) and/or determine its location based on the timing of the signals being received from two or more nearby base stations. It will be appreciated that the UE 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the other peripherals 138 may include an accelerometer, an e-compass, a satellite transceiver, a digital camera (for photographs or video), a universal serial bus (USB) port, a vibration device, a television transceiver, a hands free headset, a Bluetooth™ module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the UEs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the UEs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the UE 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the UEs 102a, 102b, 102c, bearer activation/deactivation, selecting a particular serving gateway during an initial attach of the UEs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the Si interface. The serving gateway 144 may generally route and forward user data packets to / from the UEs 102a, 102b, 102c.

The serving gateway 144 may also perform other functions, such as anchoring user planes during inter-eNode B handovers, triggering paging when downlink data is available for the UEs 102a, 102b, 102c, managing and storing contexts of the UEs 102a, 102b, 102c, and the like.

The serving gateway 144 may also be connected to the PDN gateway 146, which may provide the UEs 102a, 102b, 102c with access to packet-switched networks, such as the Internet 110, to facilitate communications between the UEs 102a, 102b, 102c and IP-enabled devices.

The core network 106 may facilitate communications with other networks. For example, the core network 106 may provide the UEs 102a, 102b, 102c with access to circuit-switched networks, such as the PSTN 108, to facilitate communications between the UES 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the UEs 102a, 102b, 102c with access to the other networks 112, which may include other wired or wireless networks that are owned and/or operated by other service providers. GPS coordinates cannot be used indoors because a signal is reflected multiple times, thereby rendering a degree of position impossible. Similarly cellular carrier signals are also reflected multiple times leading an imprecise measurement of location. However, the location of a user indoors may be specified to a degree of accuracy by use of an indoor map. One assumption that is there is that an individual keeps a UE in fairly close proximity to herself—i.e. within an arm span.

An indoor map is generated using the signals of a base station of a wireless router, Home Node B, Home eNode B, or access point, for example, and may utilize any suitable Radio Access Technology (RAT) for facilitating wireless connectivity in a localized area, such as a place of business, a home. In one embodiment, the base station 114b and the UEs 102c, 102d create a map using the radio technology known as IEEE 802.11 to establish a wireless local area network (WLAN).

A WiFi Router is mounted on a wall close to the ceiling, and the embodiment the system utilizes periodic measurements of wireless radio signal strength indication (RSSI) and transmitting the same to a to a cellular operator over a cellular RAT such as GSM, WCDMA LTE, etc.

A coarse mapping technique is employed at a pre-determined time—usually when the indoor location has minimum movement or there is no one on location, and consequently the readings are based on actual environment variables such as walls, partitions, doors, windows etc. The coarse mapping technique is used to identify RSSI position dependency and involves receiving reflection of a signal generated at the WiFi router. Another mapping technique employed is mounting a smartphone on a robot equipped with a laser range-finder. The smartphone transmits regular RSSI readings to the WiFi Router. Both coarse and robot based mapping techniques are employed to yield an accurate enough map with an extremely high density sample of signal strength information. The reason that a high density sample of signal strength information is created is because a weak signal varies with the changing conditions (or reflections). However, a strong, consistent signal occurs at a fixed location. Hence the need to conduct the mapping at a time when there is minimal movement.

This map is stored on the mounted WiFi Router, and periodically transmitted over to a cellular service provider on a cellular RAT when a smartphone user utilizes the WiFi network. When physically installing the WiFi Router, the administrator/user provides as much details as necessary to identify the address of the location. For example, address, local area, floor, mounting wall details etc. The cellular operator stores the data received from the user and uses it to direct emergency personnel in the case of an emergency.

In another embodiment, map generation data using coarse mapping, and using a smartphone mounted on robot is taken at peak times, or regularly during the day. This data is also regularly sent to the cellular service provider over a cellular RAT to be used in case of an emergency.

The RSSI data between the smartphone and the WiFi Router is based on log-distance path loss model as proposed by Rappaport. In this model, received power (in dBm) at a distance d (in meters) from the transmitter (Pr(d)) is given by:

Pr(d)=P(r)(d)+X_{σ}

Pr(d)=Prₒ−10αlog (d)+X_{σ}

where Prₒ is the signal strength 1 meter from the transmitter, α is the path loss exponent, and X_{σ}represents a Gaussian random variable with zero mean and standard deviation of cdB.

This model takes into account the different obstacles present in multiple transmitter-receiver paths with the same separation, this phenomenon referred to as log-normal shadowing. Various studies have reported empirical values for α in the range between 1.8 (lightly obstructed environments with corridors) and 5 (multi-floored buildings), while values for a usually fall into the interval [4; 12]dB.

To reduce the amount of signaling between a smartphone and a cellular service operator for sending the mapped indoor terrain, a system of grid marking is used. The grid mapping is based on RSSI data generated, and the WiFi Router may also generate the grid map and send to smartphone when a smartphone user registers with the WiFi Router.

In another embodiment, users at an airport register with their smartphone with an access point. Multiple access points (or WiFi routers) are used to map the terrain and a grid mapping system may also be employed. Once registered, the movement of the user may be tracked till departure from the airport.

In one embodiment, machine-to-machine (M2M) architecture is implemented to specify the location of a user indoors. As described, a coarse mapping is first obtained, and then a detailed pedestrian path determined over a period of time is superimposed on the coarse mapping to specify the location of the user on a grid.

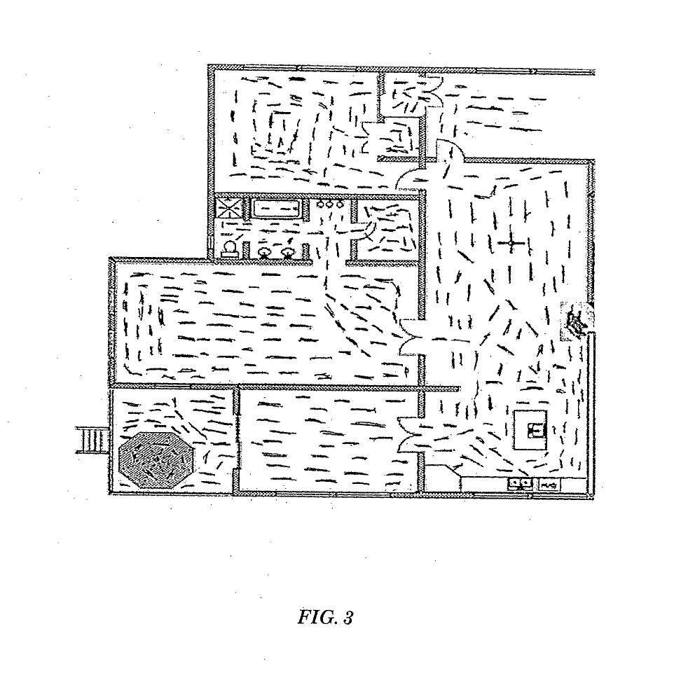

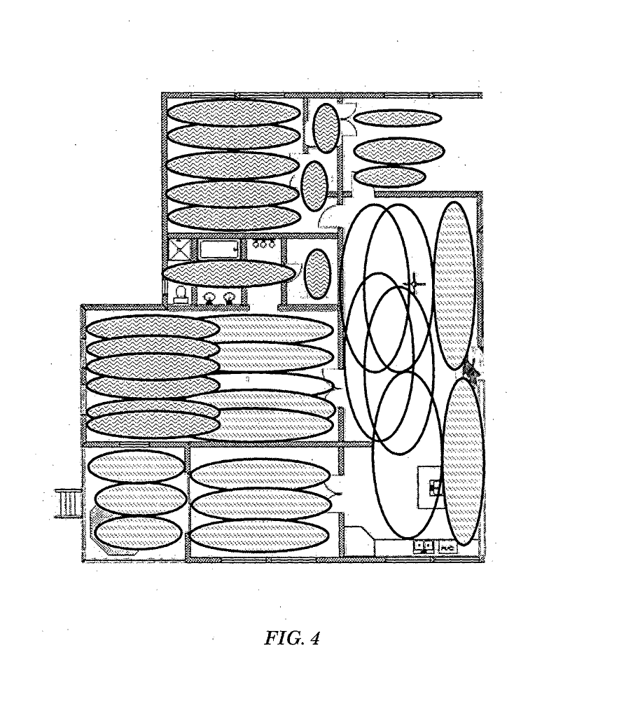

A pedestrian path is determined by observing several times the movement of a device. One characteristic of indoor locations is that a person usually walks over straight lines, because of location of various objects such as doors, windows, furniture etc. A person cannot go through a wall, but must use a pathway (a door, or avoid walking into a lounge/furniture) to reach from one distinct position to another. In a home, or office, it is not just one user that takes a particular pathway, almost all users take a particular pathway to reach a position. Such a set of possible pathways is shown in FIG. 3. At each point on any such pathway the signal is different (because of reflection, bouncing off from various objects, walls etc.) and accordingly aids in positioning of an end-user. FIG. 4, represents a possible RSSI map of an indoor house. The strength of the 802.11 a/b/g/n/ . . . signal is stronger near the WiFi router and decreases depending on the location of walls, windows, furniture etc. The representation of signal strength in FIG. 4 is approximate. Different cross-hatches are shown in FIG. 4 simply to represent that the signal strength may be different at different positions.

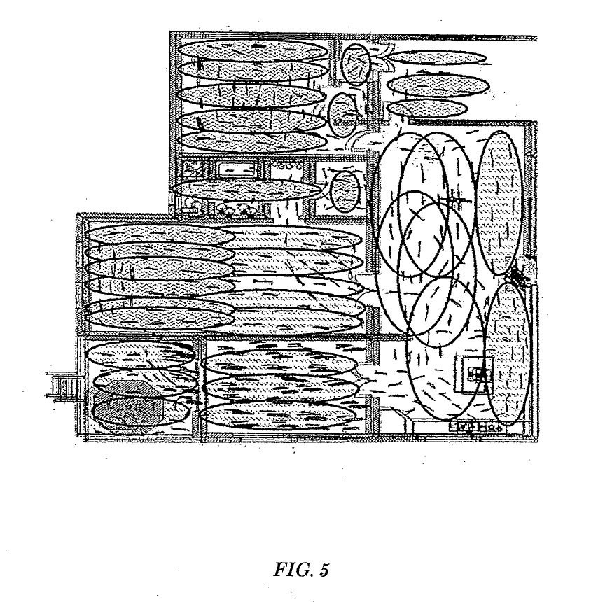

FIG. 5. represents the pathway of FIG. 3 mapped on to the RSSI map of FIG. 4. From FIG. 5, it can be seen that any position indoors be easily determined. With an M2M configuration, the UE can be easily used to locate an individual (location of UE) precisely in case of an emergency or otherwise required by law enforcement agencies, such as airports without human intervention. The position, indoor map, and signal strength indication of the indoor map is sent to an operator using a different transmission set up other than that of a Wifi router over a period of time. For any location, the initial data sent to an operator would be large because it would contain the generated location/pathway map and the signal strength indication. Over a period of time (10-15 minutes or operator defined), only the location would be transmitted, the generated location/pathway map and the signal strength indication being already provided to the operator.

In one additional embodiment, an M2M system flow for locating users indoors is provided. In one further embodiment, the location of a user is provided only to authorized personnel only on a pre-authorized device.

In the M2M configuration, a typical M2M system comprises a device, or group of devices, capable of autonomously replying to requests for data, and transmitting data without human intervention. An M2M system also may include a communications link to connect the device, or group of devices, to another device (or group of devices), wherein a software agent or underlying process analyzes, reports, and/or acts upon the requested data.

M2M clients differ from other ordinary network subscribers primarily with respect to data usage. Because M2M clients are not flexibly programmed, their software is not usually written to operate with the wide variety of services that a human subscriber can. As described earlier, many M2M services are operator determined in their times of operation, and data transmission. Operators, accordingly are currently seeking appropriate solutions to reduce the load on the system by optimizing M2M signaling. These improvement in resource management, are structured to offer attractive M2M rates/tariffs, and to meet new business models. The described embodiments, describe solutions for advanced resource management and take into account varying periods of low network traffic, and perform load-balancing functions (juggling e.g. time, location and network resources) to optimize network service.

As described, because security considerations are different for M2M devices than for standard subscribers. Accordingly, devices may include a pre-authenticated module on a System-On-Chip (SoC) for M2M transmissions. The secure M2M device could be hardware encoded (pre-authenticated) within a UE, or even a Subscriber Identity Module (SIM) card, or even as an embedded Field Programmable Gate Array (FPGA), that is designed to work with SIM cards, where the programmable part is one time programmable (hard coded after a single use) with input from the SIM card.

This protection is necessary because an unprotected M2M devices' location may be fraudulently modified or otherwise tampered with. Corrupted terminals may be used to attack the M2M system and/or the cellular network, and/or create false alarms for emergency personnel, or facilitate theft of funds or products. Perpetrators of such fraud may target an M2M user or system (e.g. via denial of service attacks, distributed denial of service attacks, man-in-the-middle attacks, message blocking, etc.), and/or the Public Land Mobile Network (PLMN) operators (e.g., via theft of service, etc.).

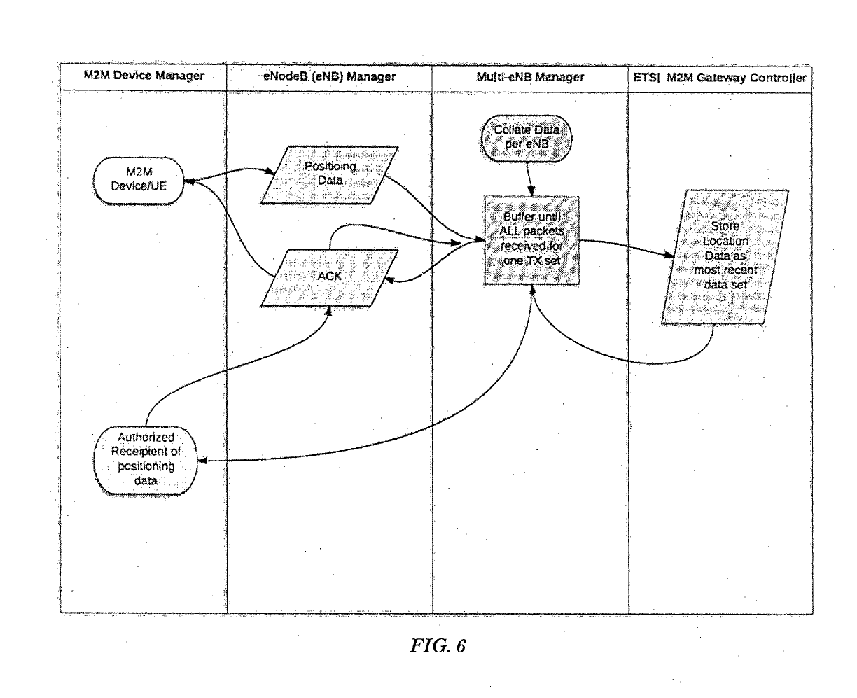

FIG. 6 represents a flow diagram of the data transmissions between the various entities involved in locating a user indoor. A UE with a ore-authenticated M2M chip gets the positioning data including the strength indication, pathways to an eNodeB (eNB) manager or its equivalent in an alternate system. The eNB manager transmits an acknowledgment to the M2M—although it is not necessary for such an acknowledgment. The eNB transfers the positioning data to a multi-eNB manager. The multi-eNB manager buffers the data for a single transmission set of positioning data. Upon completion, the multi eNB manager, transfers the data to an ETSI M2M Gateway Controller with appropriate cloud storage.

Upon a requirement by emergency personnel/authorized recipient of positioning data, a request is triggered from a pre-authorized recipient of positioning data and the M2M Gateway signals to multi-eNB Manager to initiate transmission of positioning data until entire most recent data set is transmitted to the authorized recipient of positioning data.

The embodiments as described may be implemented to locate a user indoors in an emergency, or for example, in places like airports, etc.

The location of a user indoors may be specified to a degree of accuracy by use of an indoor map. An indoor map is generated using the signals of a base station of a wireless router not employing cellular radio access technology (RAT). In one embodiment, an 802.11 Router is mounted on a wall close to the ceiling, and the embodiment utilizes periodic measurements of wireless radio signal strength indication (RSSI) to generate an indoor map, and transmitting the same to a to a cellular operator over a cellular RAT such as GSM, WCDMA LTE, etc. The signaling between smartphone and cellular RAT is reduced by mapping/converting the RSSI data into a grid based format. The cellular operator stores the data received from a smartphone user and provides it to emergency personnel in case of emergencies.

In another embodiment, instead of signal strength, a pre-defined parameter may be transmitted to the operator. This pre-defined parameter could be a combination of other parameters such as signal strength of the nearest base-station/operator, and the signal strength of the WiFi Router.

In another embodiment, a user may after mounting the WiFi Router or device in the indoor location, may specify the floor, area, locality, street address, etc.—and the WiFi Router transmits an encrypted pre-defined signal parameter based on the input entered and a registered UE transmits the same to the operator. The operator without any interference transmits the signal to emergency service personnel devices, which in cases of emergency only are able to decrypt the signal using pre-authenticated devices. That is, only emergency personnel would have the devices to decrypt the data, and only at the time of an emergency.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a UE, UE, terminal, base station, RNC, or any host computer.

1. A method to determine the location of a user indoors, comprising:
generating at a user equipment (UE), a first mapping of the indoor environment including the positioning of furniture, walls, windows, and other fixtures using a first set of signaling parameters;
generating a second mapping of a pathway for getting from one physical location point to another physical location point in the indoor location;
generating a third mapping by super-imposing the second mapping on the first mapping;
transmitting to a service operator the third mapping containing positioning data periodically using a second set of signaling parameters; and
upon receipt from a device of an authorized recipient of positioning data, transmitting from a gateway controller, signaling to initiate transfer of most recent positioning data, and completing signaling at the gateway controller after acknowledgment from the authorized recipient of positioning data to locate a user indoors.

2. The method of claim 1, wherein the first set of signaling parameters is associated with a first radio access transmission (RAT) system, and the second set of signaling parameters is associated with a second RAT system.

3. The method of claim 1, wherein an authorized recipient of positioning data is an emergency response personnel or a designated recipient including an airport security manager.

4. The method of claim 1, wherein the UE, and the device of an authorized recipient are hardware encoded.

5. The method of claim 1, wherein the signaling of the positioning data is operator specified.

6. A system to determine the location of a user indoors, comprising:
generating at a user equipment (UE), using a transceiver, and a processor, a first mapping of the indoor environment including the positioning of furniture, walls, windows, and other fixtures using a first set of signaling parameters;
generating, at the UE, using the transceiver, and the processor, a second mapping of a pathway for getting from one physical location point to another physical location point in the indoor location;
generating a third mapping at the processor, by super-imposing the second mapping on the first mapping;
transmitting from the UE, through the transceiver, to a service operator the third mapping containing positioning data periodically using a second set of signaling parameters; and
upon receipt from a device of an authorized recipient of positioning data, transmitting from a gateway controller, signaling to initiate transfer of most recent positioning data, and completing signaling at the gateway controller, after acknowledgment from the authorized recipient of positioning data to locate a user indoors.

7. The system of claim 6, wherein the first set of signaling parameters is associated with a first radio access transmission (RAT) system, and the second set of signaling parameters is associated with a second RAT system.

8. The system of claim 6, wherein an authorized recipient of positioning data is an emergency response personnel or a designated recipient including an airport security manager.

9. The system of claim 6, wherein the UE, and the device of an authorized recipient are hardware encoded.

10. The system of claim 6, wherein the signaling of the positioning data is operator specified.
